(19) United States
(12) Patent Application Publication
(10) Pub. No.: US 2020/0216634 A1
(43) Pub. Date: Jul. 9, 2020

(54) NONAQUEOUS SUSPENSION EXHIBITING ELECTRORHEOLOGICAL EFFECT, AND DAMPER USING SAME

(71) Applicant: HITACHI AUTOMOTIVE SYSTEMS, LTD., Ibaraki (JP)

(72) Inventors: Tomohiro OKADA, Odawara-shi, Kanagawa (JP); Yohei KATAYAMA, Yokohama-shi, Kanagawa (JP)

(21) Appl. No.: 16/638,582

(22) PCT Filed: Jul. 26, 2018
(86) PCT No.: PCT/JP2018/028004

§ 371 Date: Feb. 12, 2020

(30) Foreign Application Priority Data
Aug. 14, 2017 (JP) 2017-156522

(51) Int. Cl. C08K 3/16; F16F 9/53

(52) U.S. Cl. CPC C08K 3/16; F16F 9/185; F16F 2224/043; F16F 9/532

(57) ABSTRACT

Provided are a non-aqueous suspension exhibiting an electrorheological effect and a damper constructed using the non-aqueous suspension.

A non-aqueous suspension exhibiting an electrorheological effect, including a non-aqueous liquid; and organic polymer particles dispersed in the non-aqueous liquid, wherein the organic polymer particles have at least one type of ion in the inside or on the surface of the organic polymer particles, wherein when a 5 kV/mm voltage is applied between a pair of electrodes, the logarithmic value of frequency factor in Arrhenius equation for the current density (μA/cm²) flowing between the electrodes through the non-aqueous suspension is 20 or more.

### TECHNICAL FIELD

The present invention relates to a non-aqueous suspension exhibiting an electrorheological effect (also referred to as “ER effect”) and a damper using the suspension.

### BACKGROUND ART

Electrorheological fluids (also referred to as “ER fluids”) are fluids that can rapidly and reversibly change their apparent viscosity in the presence of an applied electric field. ER fluids are generally dispersions of finely fragmented solids in a hydrophobic and electrically non-conductive oil. The fluids, when exposed to an electric field, have an ability to change their flow characteristics even to the point of becoming solid. When the electric field is removed, the fluids revert to their normal liquid state. ER fluids can advantageously be used in dampers and other applications in which it is desired to control the transmission of forces under low levels of electric power.

Japanese Unexamined Patent Application Publication No. JP H10-081758 (PTL 1) discloses a non-aqueous dispersion (ER fluid) prepared using: as a prepolymer, a trifunctional polyethylene glycol with a molecular weight of 1015, prepared by ethoxylation of trimethylolpropane; as a non-aqueous liquid, polydimethylsiloxane (silicone oil); as a dispersant, a reaction product of 40 parts of octamethylcyclotetrasiloxane and 2 parts of N-(β-amino-ethyl)-γ-aminopropylmethyldiethoxysilane; as a curing agent, tolylene diisocyanate (TDI); and as a conductive component, LiCl or ZnCl₂ (refer to Examples of PTL 1).

PTL 1 also discloses that the amount of a curing agent depends on the number of functional groups in a liquid prepolymer, and that when curing takes place by means of polyaddition or polycondensation, the ratio of functional groups in the liquid prepolymer to functional groups in the curing agent is preferably equimolar (refer to par. [0049] of PTL 1).

### CITATION LIST

### Patent Literature

PTL 1: Japanese Unexamined Patent Application Publication No. JP H10-081758

### SUMMARY OF INVENTION

### Technical Problem

It was found that the non-aqueous dispersion (ER fluid) disclosed in PTL 1 is problematic because of not achieving adequate yield stress at low temperatures (e.g., −20° C.), and therefore that dampers constructed using this ER fluid cannot exhibit the desired characteristics at low temperatures (e.g., −20° C.) and consequently cannot serve as dampers capable of exhibiting the desired damping characteristics at low temperatures.

Therefore, the present invention has as its objects to provide a non-aqueous suspension (ER fluid) that can provide a solution to the aforementioned problem, or namely a non-aqueous suspension with an ER effect, which can achieve a satisfactory yield stress even at low temperatures, and to provide a damper that can provide a solution to the aforementioned problem, or namely a damper constructed using the aforementioned non-aqueous suspension, which can deliver the desired damping force even at low temperatures.

### Solution to Problem

As a result of intensive studies to achieve the aforementioned objects, the present inventors found that a non-aqueous suspension including a non-aqueous liquid and organic polymer particles dispersed in the non-aqueous liquid, wherein the organic polymer particles have at least one type of ion in the inside or on the surface of the organic polymer particles, wherein the non-aqueous suspension obtained using the particles is characterized in that when a 5 kV/mm voltage is applied between a pair of electrodes, the logarithmic value of frequency factor in Arrhenius equation for the current density (μA/cm²) flowing between the electrodes through the non-aqueous suspension is 20 or more, can achieve a satisfactory yield stress (e.g., 1000 Pa or more) even at low temperatures (e.g., −20° C.) (in this regard, when polyurethane particles are used as the organic polymer particles, polyurethane particles obtained by reacting a polyol with an isocyanate to give a NCO/OH equivalent ratio of 0.6 to 0.9, or polyurethane particles having an ion content of 400 ppm or more as determined by ICP-MS analysis, are capable of ensuring that the logarithmic value of frequency factor is 20 or more). Also, the inventors found that a damper constructed using the non-aqueous suspension can serve as a damper capable of suppressing excess of acceptable power supply capacity due to increased current density at high temperatures (e.g., 80° C.) with the aid of a high-resistance membrane arranged on electrodes and consequently capable of delivering a damping force over a wide temperature range from low to high temperatures. Thus, the inventors has completed the present invention.

More specifically, embodiments of the present invention are directed to the following: [1] a non-aqueous suspension exhibiting an electrorheological effect, including: a non-aqueous liquid; and organic polymer particles dispersed in the non-aqueous liquid, wherein the organic polymer particles have at least one type of ion in the inside or on the surface of the organic polymer particles, wherein when a 5 kV/mm voltage is applied between a pair of electrodes, the logarithmic value of frequency factor in Arrhenius equation for the current density (μA/cm²) flowing between the electrodes through the non-aqueous suspension is 20 or more; [2] the non-aqueous suspension as set forth in [1], wherein the organic polymer particles are polyurethane particles obtained by reacting a polyol with an isocyanate to give a NCO/OH equivalent ratio of 0.6 to 0.9; [3] the non-aqueous suspension as set forth in [1], wherein the organic polymer particles are polyurethane particles having an ion content of 400 ppm or more as determined by ICP-MS analysis; and [4] a damper including: two electrodes; the non-aqueous suspension as set forth in any one of [1] to [3] disposed between the two electrodes; and a high resistance membrane disposed on a surface of at least one of the electrodes, the surface being in contact with the non-aqueous suspension.

According to an embodiment of the present invention, there can be provided a non-aqueous suspension with an ER effect which can achieve a satisfactory yield stress even at low temperatures.

According to another embodiment of this invention, there can be provided a damper constructed using the non-aqueous suspension, which can deliver the desired damping force even at low temperatures.

### BRIEF DESCRIPTION OF DRAWINGS

FIG. 1 depicts a schematic view of the damper according to an embodiment of the present invention.

FIG. 2 depicts a longitudinal sectional view of one example of the damper of an embodiment of this invention.

FIG. 3 depicts an enlarged sectional view of section (II) in FIG. 2 which illustrates an electrode passage, a first passage, a control valve, and the like.

FIG. 4 depicts a graph showing the relationship of yield stress and current density with temperature when a 5 kV/mm voltage was applied to the non-aqueous suspension prepared in Example 1.

FIG. 5 depicts a graph showing the relationship of yield stress and current density with temperature when a 5 kV/mm voltage was applied to the non-aqueous suspension prepared in Example 3.

FIG. 6 depicts a graph showing the relationship of yield stress and current density with temperature when a 5 kV/mm voltage was applied to the non-aqueous suspension prepared in Comparative Example 1.

FIG. 7 depicts a graph showing the correlation, in each of the prepared suspensions, between the yield stress (Pa) at −10° C. and the logarithmic value of frequency factor in Arrhenius equation for the current density (μA/cm²) flowing between the electrodes upon application of a 5 kV/mm voltage.

FIG. 8 depicts a graph showing the correlation, in each of the prepared suspensions, between the yield stress (Pa) at 60° C. and the logarithmic value of frequency factor in Arrhenius equation for the current density (μA/cm²) flowing between the electrodes upon application of a 5 kV/mm voltage.

FIG. 9 depicts a graph showing the relationship of yield stress and current density with temperature when a 5 kV/mm voltage was applied to a damper constructed using electrodes having a high resistance membrane (melamine resin) formed on the surface thereof, and the non-aqueous suspension prepared in Example 1.

FIG. 10 depicts a graph showing the relationship of yield stress and current density with temperature when a 5 kV/mm voltage was applied to a damper constructed using electrodes having a high resistance membrane (phenol resin) formed on the surface thereof, and the non-aqueous suspension prepared in Example 3.

### DESCRIPTION OF EMBODIMENTS

Hereunder, embodiments of the present invention will be described in detail with reference to drawings.

The non-aqueous suspension according to an embodiment of this invention is a non-aqueous suspension exhibiting an electrorheological effect, including a non-aqueous liquid and organic polymer particles dispersed in the non-aqueous liquid, wherein the organic polymer particles have at least one type of ion in the inside or on the surface of the organic polymer particles, the non-aqueous suspension being characterized in that when a 5 kV/mm voltage is applied between a pair of electrodes through the non-aqueous suspension, the logarithmic value of frequency factor in Arrhenius equation for the current density (μA/cm²) flowing between the electrodes is 20 or more.

With regard to the organic polymer particles, the organic polymer is exemplified by polyurethane, polyamide, polyimide, polyester and the like, with polyurethane being preferred.

The particles have an average particle size ranging from 1 μm to 20 μm, preferably from 1 μm to 10 μm.

The average particle size refers to a value determined using a laser diffraction/scattering analyzer.

The organic polymer particles are present at a concentration ranging from 30 to 60 mass %, preferably from 40 to 60 mass %, based on the total mass of the non-aqueous suspension.

The ion present in the inside or on the surface of the organic polymer is preferably an ion with a small ion radius (specifically, 0.074 nm or less), and is exemplified by lithium ion, zinc ion, chromium ion, copper ion, nickel ion, cobalt ion, ferrous ion, manganese ion, tungsten ion, and the like.

As the ion, lithium ion, zinc ion, and the like are preferred, with lithium ion being more preferred.

Examples of the non-aqueous liquid include, but are not limited to, liquid hydrocarbons such as paraffins (e.g., n-nonane), olefins [e.g., 1-nonene, (cis, trans)-4-nonene] and aromatic hydrocarbons (e.g., xylene), and silicone oils such as polydimethylsiloxane and liquid methylphenylsiloxane having a viscosity of 3 to 300 mPa·s. Preferred examples of the non-aqueous liquid include silicone oils. The non-aqueous liquid can be used alone or in combination with any other non-aqueous liquid. The non-aqueous liquid has a freezing point of preferably less than −30° C., and a boiling point of preferably 150° C. or more.

To the non-aqueous suspension of an embodiment of this invention, an emulsifier may be further added.

Examples of the emulsifier that can be added to the non-aqueous suspension of an embodiment of this invention include surfactants that are soluble in a non-aqueous liquid and which are derived from, for example, an amide, imidazoline, oxazoline, an alcohol, glycol or sorbitol. A polymer soluble in a non-aqueous liquid can also be used. A suitable polymer is, for example, a polymer containing 0.1 to 10 wt. % of N and/or OH and 25 to 83 wt. % of C₄-C₂₄ alkyl groups and having a weight average molecular weight ranging from 5000 to 1000000. An N- and OH-containing compound present in such a polymer is, for example, an amino, an amide, an imide, a nitrilo, a 5- and/or 6-membered N-containing heterocyclic ring, or an alcohol, and can contain a C₄-C₂₄ alkyl ester of acrylic acid or methacrylic acid. Examples of the N- and OH-containing compound include N,N-dimethylaminoethyl methacrylate, tert-butylacrylamide, maleimide, acrylonitrile, N-vinylpyrrolidone, vinylpyridine and 2-hydroxyethyl methacrylate. Comprehensively speaking, the aforementioned polymer has an advantage over low molecular weight surfactants in that the system prepared therewith is more stable for sedimentation kinetics. Modified silicone oils such as amino-modified silicone or fluorine-modified silicone can also be used.

The non-aqueous suspension of an embodiment of this invention is characterized in that when a 5 kV/mm voltage is applied between a pair of electrodes through the non-aqueous suspension, the logarithmic value of frequency factor in Arrhenius equation for the current density (μA/cm²) flowing between the electrodes is 20 or more.

When the organic polymer particles are polyurethane particles, the polyurethane particles that can provide a non-aqueous suspension characterized in that the logarithmic value of frequency factor is 20 or more, are as follows: (A) polyurethane particles obtained by reacting a polyol with an isocyanate to give a NCO/OH equivalent ratio of 0.6 to 0.9; or (B) polyurethane particles having an ion content of 400 ppm or more as determined by ICP-MS analysis.

The following paragraphs provide descriptions of the polyurethane particles (A) as mentioned above.

Examples of the polyol used to prepare the polyurethane particles (A) include, but are not limited to:

polyetherpolyols obtained by adding one or two or more of an ethylene oxide, a propylene oxide, a butylene oxide, a styrene oxide and the like to ethylene glycol, diethylene glycol, propylene glycol, 1,4-butylene glycol, dihydroxydiphenylpropane, glycerol, hexanetriol, trimethylolpropane, pentaerythritol, sorbitol, sucrose, dipropylene glycol, dihydroxydiphenylmethane, dihydroxydiphenylether, dihydroxybiphenyl, hydroquinone, resorcin, naphthalenediol, aminophenol, aminonaphthol, a phenol-formaldehyde condensate, phloroglucin, methyldiethanolamine, ethyldiisopropanolamine, triethanolamine, ethylenediamine, hexamethylenediamine, bis(p-aminocyclohexane), tolylenediamine, diphenylmethanediamine, naphthalenediamine or the like;

polyester polyols composed of one or two or more of ethylene oxide adducts, propylene oxide adducts, butylene oxide adducts, styrene oxide adducts, and other similar adducts of ethylene glycol, diethylene glycol, propylene glycol, dipropylene glycol, trimethylene glycol, 1,3- or 1,4-butylene glycol, neopentyl glycol, 1,6-hexamethylene glycol, decamethylene glycol, bisphenol A, bisphenol F, p-xylylene glycol, 1,4-cyclohexanediol, 1,4-cyclohexanedimethanol, glycerol, trimethylolpropane, hexanetriol, pentaerythrite or the like, and of one or two or more of malonic acid, maleic acid, succinic acid, adipic acid, glutaric acid, pimelic acid, sebacic acid, oxalic acid, phthalic acid, isophthalic acid, terephthalic acid, hexahydrophthalic acid and the like; or polyols prepared by ring-opening polymerization of a cyclic ester such as propiolactone, butyrolactone or caprolactone; polyester polyols prepared with such a polyol and a cyclic ester as mentioned above; and polyester polyols prepared with the three materials: such a polyol as mentioned above, a dibasic acid, and a cyclic ester; and

polymeric polyols prepared by graft polymerization of an ethylenic unsaturated compound such as acrylonitrile, styrene or methylmethacrylate into 1,2-polybutadiene polyol, 1,4-polybutadiene polyol, polychloroprene polyol, a butadiene-acrylonitrile copolymer polyol, polydimethylsiloxane dicarbinol, poly(tetramethylene ether)glycol, a ricinoleic acid ester from castor oil, or such a polyether polyol or polyester polyol as mentioned above. Among them, polyether polyols are preferred.

Examples of the isocyanate used to prepare the polyurethane particles (A) include, but are not limited to, toluene diisocyanate, hexamethylene diisocyanate, diphenylmethane diisocyanate, isophorone diisocyanate, and methyl isocyanate.

The polyurethane particles (A) are obtained by reacting such a polyol as mentioned above with such an isocyanate as mentioned above to give a NCO/OH equivalent ratio of 0.6 to 0.9.

When the NCO/OH equivalent ratio is controlled to less than 1 in this manner, the degree of cure of the obtained polyurethane particles decreases, but the interaction between polyurethane particles and ions becomes weak, thereby rendering the ions more mobile and leading to an enhancement in the mobility of mobile ions and an increase in the number of mobile ions; thus, it is considered that these polyurethane particles are more subject to polarization even at low temperatures, and as a consequence, a satisfactory yield stress can be achieved even at low temperatures.

It is not preferable to control the NCO/OH equivalent ratio to less than 0.6, since more polyols will remain unreacted, thereby leading to a decrease in the heat resistance and durability of polyurethane particles. It is also not preferable to control the NCO/OH equivalent ratio to more than 0.9, since it will be difficult to achieve an enhancement of ion mobility and an adequate increase in the number of mobile ions.

However, if the ion concentration is made high like the polyurethane particles (B) as described below, an enhancement of ion mobility and an adequate increase in the number of mobile ions can be achieved even when the NCO/OH equivalent ratio is more than 0.9.

Examples of the ion included in the polyurethane particles (A) include ions with a small ion radius, such as lithium ion, zinc ion, chromium ion, copper ion, nickel ion, cobalt ion, ferrous ion, manganese ion, and tungsten ion.

The ion content of the polyurethane particles (A) is not particularly limited, but the polyurethane particles (A) preferably have an ion content of 300 ppm or more as determined by ICP-MS analysis.

Next, the following paragraphs provide descriptions of the polyurethane particles (B) as mentioned above.

Examples of the polyol that can be used to prepare the polyurethane particles (B) include those listed above as examples of the polyol used to prepare the polyurethane particles (A). Examples of the isocyanate that can be used to prepare the polyurethane particles (B) include those listed above as examples of the isocyanate used to prepare the polyurethane particles (A).

The polyurethane particles (B) have an ion content of 400 ppm or more as determined by ICP-MS analysis—they are high in ion concentration.

Since the polyurethane particles (B) contain a large amount of ions as mentioned above, when a voltage is applied, the polyurethane particles polarize very highly due to ion migration; thus, it is considered that these polyurethane particles are more subject to polarization even at low temperatures, and as a consequence, a satisfactory yield stress can be obtained even at low temperatures.

When the above-listed ions with a small ion radius, such as lithium ion, zinc ion, chromium ion, copper ion, nickel ion, cobalt ion, ferrous ion, manganese ion and tungsten ion, are used as the ions present in the polyurethane particles (B), an enhancement in the mobility of mobile ions and an increase in the number of mobile ions can be achieved. This is because ions with a small ion radius can easily migrate in a polymer.

In order to ensure that the ion concentration can be made as high as 400 ppm or more like the polyurethane particles (B), lithium ions are particularly preferably used.

The NCO/OH equivalent ratio in a polyol and an isocyanate reacted to prepare the polyurethane particles (B) is not particularly limited. However, as mentioned above, if the NCO/OH equivalent ratio is controlled to less than 0.6, more polyols will remain unreacted, thereby leading to a decrease in the heat resistance and durability of polyurethane particles. Therefore, the NCO/OH equivalent ratio is preferably controlled to 0.6 or more.

The NCO/OH equivalent ratio in a polyol and an isocyanate reacted to prepare the polyurethane particles (B) specifically ranges from 0.6 to 1.0, from 0.9 to 1.0, or the like. The NCO/OH equivalent ratio may also be 1.

The following paragraphs provide descriptions of a method for preparing the non-aqueous suspension of an embodiment of this invention.

The non-aqueous suspension of an embodiment of this invention can be typically prepared by suspending organic polymer particles, together with a salt (e.g., halide) of lithium, zinc, chromium, copper, nickel, cobalt, iron, manganese, tungsten or the like, and an emulsifier, etc., in a non-aqueous liquid.

When the organic polymer particles are polyurethane particles, the non-aqueous suspension can be prepared by the following procedure: a polyol and a salt (e.g., halide) of lithium, zinc, chromium, copper, nickel, cobalt, iron, manganese, tungsten or the like are added to a non-aqueous liquid such as silicone oil (in the case of using the polyurethane particles (B), these components are added in such an amount that the ion content of the polyurethane particles is 400 ppm or more as determined by ICP-MS analysis); the mixture is stirred until the salt dissolves; an emulsifier and the like are added, followed by addition of an isocyanate as a curing agent (in the case of using the polyurethane particles (A), this agent is added in such an amount as to give a NCO/OH equivalent ratio of 0.6 to 0.9); and the mixture is reacted by heating.

The heating temperature is, for example, in the range of 50° C. to 100° C., and the heating time is, for example, in the range of about 1 to 48 hours.

The thus-prepared non-aqueous suspension of an embodiment of this invention exhibits a satisfactory ER effect even at low temperatures.

Another embodiment of the present invention is directed to a damper having a structure in which the non-aqueous suspension described above is disposed between two electrodes, the damper being characterized in that a high resistance membrane is disposed on a surface of at least one of the electrodes, the surface being in contact with the non-aqueous suspension.

The high resistance membrane disposed on a surface of the electrode(s) is, for example, a membrane with a specific resistance ranging from 10⁹ to 10¹⁴ Ωcm, or a membrane with a specific resistance ranging from 10¹² to 10¹⁴ Ωcm.

Examples of such a membrane are those including an acrylic resin, a vinyl chloride resin, a melamine resin, a nylon resin, a polyester resin, a urethane resin, an epoxy resin, or a phenolic resin. The high resistance membrane may be disposed on each of the two electrodes or on either one of them, as long as the purpose of increasing resistance between the electrodes can be achieved. When the membrane is disposed on either one of the electrodes, it is desirable to use a membrane with a thickness two times that of a membrane to be disposed on each of the two electrodes.

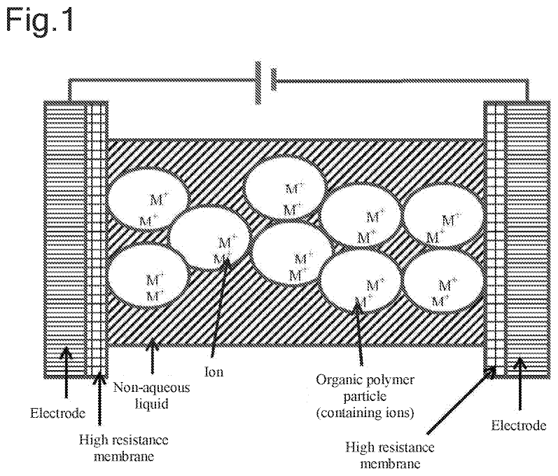

Here, the damper of an embodiment of the present invention is summarized by reference to FIG. 1.

The non-aqueous suspension of an embodiment of this invention, in which organic polymer particles having an ion (M⁺) are dispersed in a non-aqueous liquid, is disposed between two electrodes, and high resistance membranes are formed on those surfaces of the electrodes, which are in contact with the non-aqueous suspension of an embodiment of this invention. When a voltage is applied between the two electrodes, the non-aqueous suspension of an embodiment of this invention changes in flow characteristics, whereby a damping force is obtained.

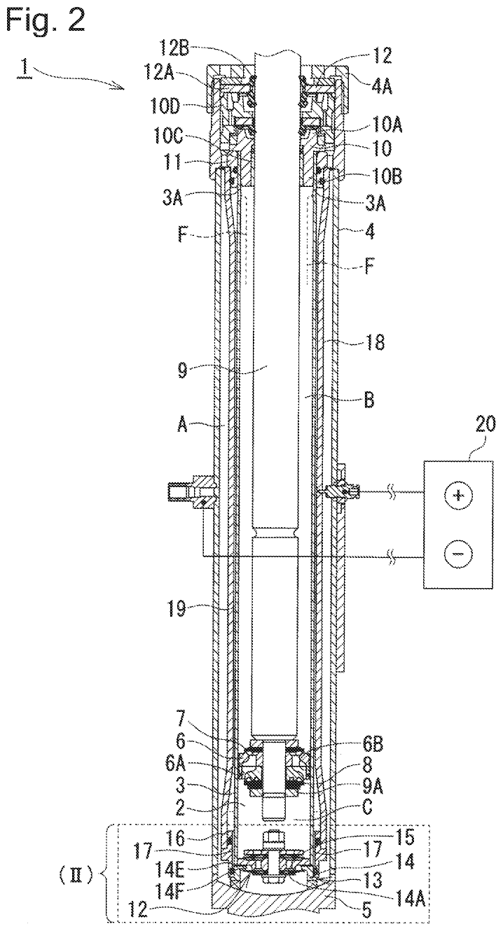

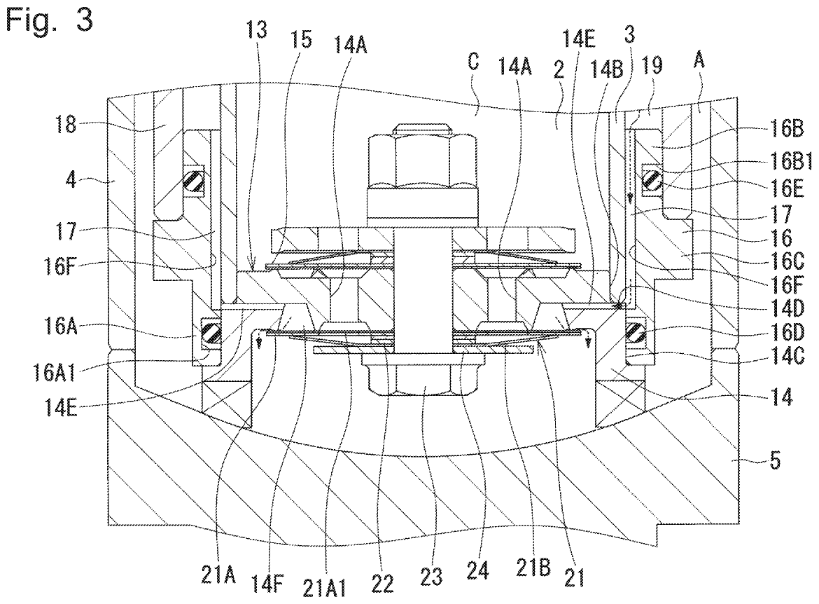

Next, one example of the damper of an embodiment of the present invention is described by reference to FIGS. 2 and 3.

FIGS. 2 and 3 depict one example of the damper of an embodiment of the present invention. In FIG. 2, a damper 1 serving as a cylinder apparatus is configured as a damping force adjusting-type hydraulic damper (semi-active damper) that uses the non-aqueous suspension 2 of an embodiment of this invention as a working fluid to be enclosed inside. The damper 1, typically along with a suspension spring (not shown) composed of a coil spring, constitutes a vehicle suspension device. In the following descriptions, one axial end side of the damper 1 is referred to as a “lower end” side, and the other axial end side as an “upper end” side. However, one and the other axial ends of the damper 1 may be regarded as an “upper end” side and a “lower end” side, respectively.

The damper 1 is configured to include an inner cylinder 3, an outer cylinder 4, a piston 6, a piston rod 9, a bottom valve 13, an electrode cylinder 18, and the like. The inner cylinder 3, the outer cylinder 4 and the electrode cylinder 18 have a high resistance membrane (refer to FIG. 1; not shown in FIG. 2 or 3) disposed on the surface thereof which is in contact with the non-aqueous suspension 2 of an embodiment of this invention. The inner cylinder 3, which is formed as an axially extending, cylindrically shaped cylinder, has enclosed therein the non-aqueous suspension 2 of an embodiment of this invention. In the inside of the inner cylinder 3, a piston rod 9 as described below is inserted. On the outside of the inner cylinder 3, the outer cylinder 4 and the electrode cylinder 18 as described below are coaxially arranged. The high resistance membrane may be disposed on each of the inner peripheral side of the electrode cylinder 18 and the outer peripheral side of the inner cylinder 3, or may be disposed only on the outer peripheral side of the inner cylinder 3. The membrane, when being disposed only on the outer peripheral side of the inner cylinder 3, is made twice thicker than the one to be disposed also on the inner peripheral side of the electrode cylinder 18. Since the inner cylinder 3 and the electrode cylinder 18 are of a cylindrical shape, it is preferable from the viewpoint of productivity that the high resistance membrane be disposed only on the outer peripheral side of the inner cylinder 3.

The lower end side of the inner cylinder 3 is fitted and mounted to a valve body 14 of a bottom valve 13 as described below. The upper end side of the inner cylinder 3 is fitted and mounted to a rod guide 10 as described below. On the inner cylinder 3, a plurality of (e.g., four) oil holes 3A that are in constant communication with an electrode passage 19 as described below are formed as radially horizontal holes in such a way as to separate from each other in the circumferential direction. In other words, a rod-side oil chamber B in the inner cylinder 3 is in communication with the electrode passage 19 through the oil holes 3A.

The outer cylinder 4 serves as an outer shell of the damper 1, and is formed as a cylindrical body. The outer cylinder 4 is provided on the outer periphery of the electrode cylinder 18, and a reservoir chamber A that is in communication with the electrode passage 19 is formed between the outer cylinder 4 and the electrode cylinder 18. In this configuration, the lower end of the outer cylinder 4 is a closed end sealed with a bottom cap 5 using a welding means or the like. The bottom cap 5, along with the valve body 14 of the bottom valve 13, constitutes a base member.

The upper end of the outer cylinder 4 is an open end. A cap member 4A is mounted on the open end of the outer cylinder 4. The cap member 4A holds the outer periphery of an annular plate 12A of a seal member 12 as described below in a locked state.

The inner cylinder 3 and the outer cylinder 4 constitute a cylinder, in which the non-aqueous suspension 2 of an embodiment of this invention is enclosed. In FIGS. 2 and 3, the non-aqueous suspension 2 of an embodiment of this invention enclosed in the cylinder is depicted as colorless and transparent.

As described later, the damper 1 is configured to control (adjust) generated damping force by generating a potential difference in the electrode passage 19 located between the inner cylinder 3 and the electrode cylinder 18 and controlling the viscosity of the non-aqueous suspension 2 of an embodiment of this invention passing through the electrode passage 19.

An annular reservoir chamber A serving as a reservoir is formed between the inner cylinder 3 and the outer cylinder 4, or more specifically between the electrode cylinder 18 and the outer cylinder 4. In the reservoir chamber A, not only the non-aqueous suspension 2 of an embodiment of this invention but also a gas serving as a working gas are enclosed. The gas may be air at atmospheric pressure or a gas such as compressed nitrogen gas. When the piston rod 9 is contracted (in a contraction stroke), the gas in the reservoir chamber A is compressed to compensate for the volume of the piston rod 9 being inserted.

The piston 6 is slidably arranged inside the inner cylinder 3. The piston 6 separates the interior of the inner cylinder 3 into a rod-side oil chamber B as a first chamber and a bottom-side oil chamber C as a second chamber. On the piston 6, a plurality each of oil passages 6A, 6B that allow communication between the rod-side oil chamber B and the bottom-side oil chamber C are formed in such a way as to separate from each other in the circumferential direction.

The damper 1 of an embodiment of the present invention has a uni-flow structure. Due to this structure, in both of the contraction and extension strokes of the piston rod 9, the non-aqueous suspension 2 of an embodiment of this invention in the inner cylinder 3 circulates at all times in one direction from the rod-side oil chamber B (i.e., the oil holes 3A on the inner cylinder 3) toward the electrode passage 19 (i.e., in the direction of arrow F shown by a dashed-two dotted line in FIG. 2). The damper 1 may have a bi-flow structure that also allows communication between the bottom-side oil chamber C and the reservoir chamber A.

In order that such a uni-flow structure can be realized, the piston 6 has provided on the upper end face thereof, for example, a contraction-side check valve 7 serving as a first check valve that opens when the piston 6 is slid and displaced downward within the inner cylinder 3 in the contraction stroke of the piston rod 9, and closes otherwise. The contraction-side check valve 7 allows an oil liquid (i.e., the non-aqueous suspension 2 of an embodiment of this invention) in the bottom-side oil chamber C to circulate through the oil passages 6A toward the rod-side oil chamber B, and prevents the oil liquid from flowing back in the opposite direction. In other words, the contraction-side check valve 7 allows only the circulation of the non-aqueous suspension 2 of an embodiment of this invention from the bottom-side oil chamber C toward the rod-side oil chamber B.

The piston 6 has, for example, an extension-side disc valve 8 provided on the lower end face thereof. The extension-side disc valve 8 opens as the pressure in the rod-side oil chamber B exceeds a relief set pressure when the piston 6 is slid and displaced upward within the inner cylinder 3 in the extension stroke of the piston rod 9, and relieves the pressure toward the bottom-side oil chamber C through the oil passages 6B.

The piston rod 9 extends within the inner cylinder 3 in the axial direction (i.e., in the same direction as the center axis of the inner cylinder 3 and the outer cylinder 4, and thus as the center axis of the damper 1; and in the vertical direction in FIGS. 2 and 3). In other words, the lower end of the piston rod 9 is connected (fixed) to the piston 6 within the inner cylinder 3, and the upper end of the piston rod 9 extends through the rod-side oil chamber B to the outside of the inner cylinder 3 and the outer cylinder 4. In this configuration, the piston 6 is fixed (adhered) to the lower end of the piston rod 9 using a nut 9A or the like. In contrast, the upper end of the piston rod 9 projects outward through the rod guide 10. Additionally, the lower end of the piston rod 9 may be further elongated to project outward from the bottom (e.g., bottom cap 5)—or namely, the piston rod 9 may be made into a double rod.

On the upper end side of the inner cylinder 3 and the outer cylinder 4, a stepped cylindrical rod guide 10 is fitted and provided in such a way as to close the upper end side of the inner cylinder 3 and the outer cylinder 4. The rod guide 10, which provides support for the piston rod 9, is formed as a cylinder of a specified shape made by molding or cutting a metal material, a hard resin material, or the like. The rod guide 10 positions the upper part of the inner cylinder 3 and the upper part of an electrode cylinder 18 as described below in the center of the outer cylinder 4. At the same time, the rod guide 10 slidably guides the piston rod 9 in the axial direction on the inner peripheral side thereof.

The rod guide 10 is formed in a stepped cylindrical shape with an annular large-diameter part 10A located upward, and with a short cylindrical small-diameter part 10B that is located on the lower end side of the large-diameter part 10A and inserted into the inner peripheral side of the inner cylinder 3. On the inner peripheral side of the small-diameter part 10B of the rod guide 10, a guide part 10C is provided, which slidably guides the piston rod 9 in the axial direction. The guide part 10C is formed by, for example, applying a tetrafluoroethylene coating onto the inner peripheral surface of a metal cylinder.

In contrast, an annular holding member 11 is abutted on a shoulder part formed between the large-diameter part 10A and the small-diameter part 10B on the outer peripheral side of the rod guide 10. The holding member 11 is interposed between the inner cylinder 3 and an electrode cylinder 18 as described below. The holding member 11, which is formed of, for example, an electrically insulating material (isolator), keeps the inner cylinder 3 and the rod guide 10 electrically insulated from the electrode cylinder 18.

A spacer member 10D and an annular seal member 12 are disposed between the rod guide 10 and the cap member 4A. The seal member 12 is configured to include a metallic annular plate 12A having in its center a hole into which to insert the piston rod 9, and an elastic body 12B composed of an elastic material such as rubber and adhered to the annular plate 12A by baking or other means. The seal member 12 is configured to allow the inner periphery of the elastic body 12B to be in slidable contact with the outer periphery of the piston rod 9, so that the seal member can airtightly and liquid-tightly seal a gap between itself and the piston rod 9.

On the lower end side of the inner cylinder 3, a bottom valve 13 is located and disposed between the inner cylinder 3 and the bottom cap 5. The bottom valve 13 serving as a body valve allows or interrupts communication between the bottom-side oil chamber C and the reservoir chamber A. For this purpose, the bottom valve 13 is configured to include a valve body 14 and an extension-side check valve 15 serving as a second check valve. The valve body 14 defines the reservoir chamber A and the bottom-side oil chamber C at a location between the bottom cap 5 and the inner cylinder 3.

On the valve body 14, oil passages 14A that allow communication between the reservoir chamber A and the bottom-side oil chamber C are formed in such a way as to separate from each other in the circumferential direction. On the outer peripheral side of the valve body 14, there are formed a small-diameter part 14B located upward and fitted and fixed to the lower end inner peripheral side of the inner cylinder 3, and a large-diameter part 14C located on the lower end side of the small-diameter part 14B and fitted and fixed to the lower end inner peripheral side of a holding member 16 as described below. Between the small-diameter part 14B and the large-diameter part 14C, a stepped part 14D abutting on the lower end of the inner cylinder 3 is formed. The stepped part 14D abuts on the lower end edge of the inner cylinder 3.

The valve body 14 is configured to have a plurality of radially extending radial passages 14E formed thereon in such a way as to separate from each other in the circumferential direction. In this configuration, each of the radial passages 14E is composed of a radially extending recessed groove formed on the stepped part 14D, and an oil hole formed to be continuous with the recessed groove and extending toward the central axis side of the valve body 14. The radial passages 14E are connected to an annular passage 14F arranged on the lower face side of the valve body 14 so as to surround the oil passages 14A. The annular passage 14F is composed of an annular recessed groove that opens toward the lower face side of the valve body 14. The radial passages 14E and the annular passage 14F, along with holding member-side passages 17 as described below, constitute a first passage for circulating the non-aqueous suspension 2 of an embodiment of this invention. On the annular passage 14F, a control valve 21 as described below is provided to cover the annular passage 14F.

The extension-side check valve 15 is provided, for example, on the upper face side of the valve body 14. The extension-side check valve 15 opens when the piston 6 is slid and displaced upward in the extension stroke of the piston rod 9, and closes otherwise. The extension-side check valve 15 allows an oil liquid (i.e., the non-aqueous suspension 2 of an embodiment of this invention) in the reservoir chamber A to circulate through the oil passages 6A toward the bottom-side oil chamber C, and prevents the oil liquid from flowing back in the opposite direction. In other words, the extension-side check valve 15 allows only the circulation of the non-aqueous suspension 2 of an embodiment of this invention from the reservoir chamber A toward the bottom-side oil chamber C.

The holding member 16 is fitted and mounted to the large-diameter part 14C of the valve body 14 and to the lower end outer peripheral side of the inner cylinder 3. The holding member 16 holds the lower end side of the electrode cylinder 18 in a state of being positioned in the axial direction. The holding member 16, which is formed of, for example, an electrically insulating material (isolator), keeps the inner cylinder 3 and the valve body 14 electrically insulated from the electrode cylinder 18.

The holding member 16 includes a lower cylindrical part 16A serving as a first cylindrical part, an upper cylindrical part 16B serving as a second cylindrical part, and an annular collar part 16C. The lower cylindrical part 16A is fitted to the large-diameter part 14C of the valve body 14. On the inner peripheral surface of the lower cylindrical part 16A, there is formed a seal groove 16A1 which is a circumferential groove extending over the whole periphery. In the seal groove 16A1, a seal member 16D is provided for liquid-tightly sealing a gap between the holding member 16 and the valve body 14.

In contrast, the upper cylindrical part 16B is fitted to the inner cylinder 3. Also, the outer peripheral side of the upper cylindrical part 16B is fitted to the lower end inner peripheral side of the electrode cylinder 18. On that portion of the outer peripheral surface of the upper cylindrical part 16B, which faces the electrode cylinder 18, there is formed a seal groove 16B1 which is a circumferential groove extending over the whole periphery. In the seal groove 16B1, a seal member 16E is provided for liquid-tightly sealing a gap between the holding member 16 and the electrode cylinder 18. The annular collar part 16C is provided on the outer peripheral side of the upper cylindrical part 16B. The annular collar part 16C abuts on the lower end of the electrode cylinder 18, so that the annular collar part 16C positions the electrode cylinder 18 in the axial direction.

On that portion of the inner peripheral surface of the holding member 16, which radially faces the outer peripheral surface of the inner cylinder 3, and on that portion of the large-diameter part 14C of the valve body 14, which faces the radial passages 14E, there are formed a plurality of axially extending recessed grooves 16F. Each of the recessed grooves 16F is connected to each of the radial passages 14E. The recessed grooves 16F form a plurality of holding member-side passages 17 which extend in the axial direction between the inner diameter side of the holding member 16 and the outer peripheral surface of the inner cylinder 3.

The holding member-side passages 17 are connected to the radial passages 14E of the valve body 14 and then to the annular passage 14F. Thus, the holding member-side passages 17, the radial passages 14E, and the annular passage 14F constitute a first passage that communicates the rod-side oil chamber B with the reservoir chamber A through the electrode passage 19. In other words, the electrode passage 19 and the reservoir chamber A are communicated through the holding member-side passages 17, the radial passages 14E, and the annular passage 14F.

On the outside of the inner cylinder 3, or namely, in a location between the inner cylinder 3 and the outer cylinder 4, there is arranged an electrode cylinder 18 which is composed of an axially extending pressure tube. The electrode cylinder 18 serves as an intermediate cylinder located between the inner cylinder 3 and the outer cylinder 4. The electrode cylinder 18, which is formed of an electrically conductive material, constitutes a cylindrical electrode. Between the electrode cylinder 18 and the inner cylinder 3, the electrode passage 19 which communicates with the rod-side oil chamber B is formed.

In other words, the electrode cylinder 18 is mounted on the outer peripheral side of the inner cylinder 3 through the holding members 11, 16 which are disposed to be separated from each other in the axial (vertical) direction. The electrode cylinder 18 surrounds the outer peripheral side of the inner cylinder 3 all over the whole periphery of the inner cylinder 3, and thereby forms an annular passage (flow passage) in the inside of the electrode cylinder 18, i.e., between the inner peripheral side of the electrode cylinder 18 and the outer peripheral side of the inner cylinder 3—that is, the electrode cylinder 18 thus forms the electrode passage 19 serving as an intermediate passage for circulating the non-aqueous suspension 2 of an embodiment of this invention.

The electrode passage 19 is in constant communication with the rod-side oil chamber B through the oil holes 3A formed as radially horizontal holes on the inner cylinder 3. In other words, as shown by arrow F in FIG. 2, which indicates the direction of flow of the non-aqueous suspension 2 of an embodiment of this invention, the non-aqueous suspension 2 of an embodiment of this invention in the damper 1 circulates from the rod-side oil chamber B through the oil holes 3A to the electrode passage 19 in both of the compression and extension strokes of the piston 6. After flowing into the electrode passage 19, the non-aqueous suspension 2 of an embodiment of this invention flows axially from the upper end side to the lower end side of the electrode passage 19 as the piston rod 9 advances and retreats in the inner cylinder 3 (i.e., while the contraction and extension strokes of the piston are repeated). The non-aqueous suspension 2 of an embodiment of this invention, which has flowed into the electrode passage 19, flows out from the lower end side of the electrode cylinder 18 through a control valve 21 as described below to the reservoir chamber A.

Additionally, although not shown in figures, a partition member that partitions the electrode passage 19 for circulating the non-aqueous suspension 2 of an embodiment of this invention (to guide the flow of the non-aqueous suspension 2 of an embodiment of this invention) may be provided between the inner peripheral side of the electrode cylinder 18 and the outer peripheral side of the inner cylinder 3. In other words, the partition member (flow passage forming member) may be provided on the inner peripheral surface of the electrode cylinder 18 or on the outer peripheral surface of the inner cylinder 3 so as to be relatively unrotatable with respect to the electrode cylinder 18 or the inner cylinder 3, so that the partition member can guide the non-aqueous suspension 2 of an embodiment of this invention not only in the axial direction but also in the circumferential direction. With the use of this partition member, one or a plurality of helical or meandering passages (flow passages) having a circumferentially extending part can be adopted as a passage(s) for circulating the non-aqueous suspension 2 of an embodiment of this invention. In the case of adopting such a passage(s), the length of the flow passage from the oil holes 3A to the holding member-side passages 17 can be made longer as compared to a passage(s) extending straight in the axial direction.

The electrode passage 19 gives a resistance to a fluid that circulates in the outer cylinder 4 and the inner cylinder 3 by means of the sliding motions of the piston 6—i.e., an electrorheological fluid serving as the non-aqueous suspension 2 of an embodiment of this invention. For this purpose, the electrode cylinder 18 is connected to a positive electrode of a battery 20 serving as a powder source, for example through a high-voltage driver (not shown) that generates a high voltage. The battery 20 (and the high-voltage driver) serves as a voltage supply section (electric field supply section), and the electrode cylinder 18 serves as an electrode that applies an electric field (voltage) to the non-aqueous suspension 2 of an embodiment of this invention which is a fluid present in the electrode passage 19—i.e., to an electrorheological fluid serving as a functional fluid. In this configuration, both end sides of the electrode cylinder 18 are electrically insulated by the electrically insulating holding members 11, 16. On the other hand, the inner cylinder 3 is connected to a negative electrode (ground) through the rod guide 10, the bottom valve 13, the bottom cap 5, the outer cylinder 4, the high-voltage driver, and the like.

The high-voltage driver boosts a DC voltage outputted from the battery 20 and supplies (outputs) the boosted voltage to the electrode cylinder 18, based on a command (high-voltage command) outputted from a controller (not shown) for variably controlling the damping force of the damper 1. Thereby, a potential difference according to the voltage applied to the electrode cylinder 18 is generated between the electrode cylinder 18 and the inner cylinder 3, or namely in the interior of the electrode passage 19, resulting in a change in the viscosity of the non-aqueous suspension 2 of an embodiment of this invention which is an electrorheological fluid. In this configuration, the damper 1 can continuously adjust the characteristics of generated damping force (damping force characteristics) from hard (hard characteristics) to soft (soft characteristics), according to the voltage applied to the electrode cylinder 18. Additionally, the damper 1 may be capable of adjusting damping force characteristics in a two or multiple step manner, even if not continuously.

The following paragraphs provide descriptions of the first passage and the control valve 21 according to an embodiment of the present invention.

The control valve 21 is a valve that generates a damping force (damping force control valve). The control valve 21 is provided in a first passage that communicates the rod-side oil chamber B and the reservoir chamber A through the electrode passage 19, or more specifically in a first passage that communicates from the electrode passage 19 through the bottom valve 13 to the reservoir chamber A. The first passage, which is constituted by the holding member-side passages 17, the radial passages 14E and the annular passage 14F, is a passage that, along with the electrode passage 19, allows communication between the rod-side oil chamber B and the reservoir chamber A. Also, the control valve 21 is provided in the first passage of the bottom valve 13, or more specifically on the downstream side (downstream end) of the annular passage 14F of the valve body 14. In other words, the control valve 21 is provided to cover the opening at the downstream end of the annular passage 14F.

The control valve 21 is composed of a disc 21A serving as an annular shutoff valve (valve body) provided on the downstream side of the electrode passage 19, and a plate spring 21B serving as an elastic member that energizes the disc 21A. A retainer 22 is disposed between the disc 21A and the plate spring 21B. If the plate spring 21B can be omitted, the control valve 21 may be composed of only a shutoff valve, such as a multi-disc (multiple discs). The disc 21A, the plate spring 21B, and the retainer 22 are clamped between the lower surface of the valve body 14 and a washer 24 using a bolt and nut 23. The disc 21A has through holes 21A1 formed thereon at locations opposite to the oil passages 14A of the valve body 14. The through holes 21A1 are intended to ensure that the non-aqueous suspension 2 of an embodiment of this invention in the reservoir chamber A is not interrupted from flowing toward the oil passages 14A of the valve body 14.

When the disc 21A is seated on the opening (periphery) of the annular passage 14F, the control valve is in a closed state in which the annular passage 14F is blocked. When the disc 21A is separated (stays away) from the opening (periphery) of the annular passage 14F, the control valve is in an opened state in which the annular passage 14F is in communication with the reservoir chamber A. Additionally, FIGS. 2 and 3 depict a closed valve state.

In an embodiment of the present invention, the control valve 21 can be adjusted depending on, for example, the type, specification and/or the like of a vehicle equipped with the damper 1. More specifically, the orifice area of the control valve 21, the spring stiffness (elastic force, energizing force) of the disc 21A and the plate spring 21B, and the port area of the control valve 21 (e.g., the opening area of the annular passage 14F of the valve body 14) can be adjusted (varied) depending on the type, specification and/or the like of a vehicle equipped with the damper 1. In this process, for example, adjusting the orifice area allows for tuning of the damping force characteristics in a low piston speed region. Adjusting the spring stiffness allows for tuning of the damping force characteristics in a middle piston speed region. Adjusting the port area allows for tuning of the damping force characteristics in a high piston speed region. In other words, the control valve 21 enables adjustment (alteration) of damping force in relation to piston speed. Thus, in an embodiment of the present invention, the damping force characteristics of the damper 1 can be tuned as desired through adjustment of the control valve 21.

The damper 1 according to an embodiment of the present invention has such a configuration as described above. Next, the following paragraphs provide descriptions of the operation of the damper 1.

When the damper 1 is mounted to a vehicle such as automobile, for example, the upper end side of the piston rod 9 is attached to the body side of the vehicle, and the lower end side (bottom cap 5 side) of the outer cylinder 4 is attached to the wheel side (axial side) of the vehicle. During the travel of the vehicle, when vibrations in the vertical direction occur due to road surface irregularity, etc., the piston rod 9 is displaced to extend from or contract into the outer cylinder 4. Then, a potential difference is generated in the electrode passage 19 based on a command from a controller, to control the viscosity of the non-aqueous suspension 2 of an embodiment of this invention, i.e., an electrorheological fluid passing through the electrode passage 19, and thereby to variably adjust the generated damping force of the damper 1.

For example, in the extension stroke of the piston rod 9, the contraction-side check valve 7 of the piston 6 is closed by means of the movement of the piston 6 in the inner cylinder 3. Before the disc valve 8 of the piston 6 is opened, an oil liquid (i.e., the non-aqueous suspension 2 of an embodiment of this invention) in the rod-side oil chamber B is pressurized to flow through the oil holes 3A on the inner cylinder 3 into the electrode passage 19. Then, the extension-side check valve 15 of the bottom valve 13 opens, so that the oil liquid at a volume equal to that traveled by the piston 6 flows from the reservoir chamber A into the bottom-side oil chamber C.

On the other hand, in the contraction stroke of the piston rod 9, the contraction-side check valve 7 of the piston 6 is opened and the extension-side check valve 15 of the bottom valve 13 is closed, by means of the movement of the piston 6 in the inner cylinder 3. Then, an oil liquid in the bottom-side oil chamber C flows into the rod-side oil chamber B. At the same time, the oil liquid at a volume equal to that traveled by the piston rod 9 in the inner cylinder 3 flows from the rod-side oil chamber B through the oil holes 3A on the inner cylinder 3 into the electrode passage 19.

In both cases (in both of the extension and contraction strokes), the non-aqueous suspension 2 of an embodiment of this invention flowing into the electrode passage 19 passes through the electrode passage 19 toward the outlet side (lower side) at a viscosity varied according to a potential difference generated in the electrode passage 19 (i.e., a potential difference between the electrode cylinder 18 and the inner cylinder 3), and flows from the electrode passage 19 through the control valve 21 into the reservoir chamber A. Then, the damper 1 generates a damping force varied depending on the viscosity of non-aqueous suspension 2 of an embodiment of this invention passing through the electrode passage 19, and a damping force varied depending on the orifice area, spring stiffness, port area, etc. of the control valve 21, so that it can buffer (damp) vertical vibrations of a vehicle.

As described above, according to an embodiment of the present invention, the first passage that communicates the rod-side oil chamber B with the reservoir chamber A through the electrode passage 19, or more specifically, the control valve 21 that generates a damping force in the annular passage 14F of the valve body 14, is provided in the damper 1. Thus, the damper 1 can deliver both of a damping force based on passing of the non-aqueous suspension 2 of an embodiment of this invention through the electrode passage 19, and a damping force based on passing of the non-aqueous suspension 2 through the control valve 21. Therefore, as shown in FIG. 3, the damping force characteristics in each of low, middle and high piston speed regions can be tuned as desired through adjustment of the orifice area, spring stiffness and port area of the control valve 21. As a consequence, besides the adjustment of a damping force through voltage adjustment during passing of the non-aqueous suspension 2 of an embodiment of this invention through the electrode passage 19, there are more ways to tune damping force characteristics as desired—the degree of freedom of tuning can be increased. In other words, by making adjustments (settings) to the control valve 21, there can be provided different types of dampers 1 which differ in damping force characteristics depending on the type, specification, etc. of a vehicle, so that mass production cost can be reduced.

According to an embodiment of the present invention, the control valve 21 is composed of a disc 21A provided on the downstream side of the electrode passage 19, and a plate spring 21B that energizes the disc 21A. Therefore, damping force characteristics can be finely tuned through adjusting the spring stiffness (elastic force, energizing force) of the disc 21A and/or the plate spring 21B, and the orifice area and port area of the disc 21A. In this process, damping force characteristics can also be tuned as desired by, for example, making adjustment (alteration) only to the disc 21A. This enables the reduction of component cost—also from this viewpoint, mass production cost can be reduced. Further, since (the disc 21A of) the control valve 21 is provided on the downstream side of the electrode passage 19, a high-pressure gas in the reservoir chamber A can be prevented from entering (flowing back into) the electrode passage 19. This prevents a decrease in electrical insulation.

According to an embodiment of the present invention, the holding member-side passages 17, the radial passages 14E and the annular passage 14F which constitute the first passage, communicate from the electrode passage 19 to the reservoir chamber A through the bottom valve 13, and the control valve 21 is provided in the annular passage 14F of the valve body 14 constituting the bottom valve 13. Therefore, the control valve 21 can be incorporated utilizing the valve body 14 of the bottom valve 13 which is originally provided in the damper. This prevents, for example, complication and an increase in size of the control valve 21, and an increase in the number of components of the control valve 21.

According to an embodiment of the present invention, the piston 6 has provided thereon the contraction-side check valve 7, which allows only the circulation of the non-aqueous suspension 2 of an embodiment of this invention from the bottom-side oil chamber C toward the rod-side oil chamber B, and the bottom valve 13 has provided thereon the extension-side check valve 15, which allows only the circulation of the non-aqueous suspension 2 of an embodiment of this invention from the reservoir chamber A toward the bottom-side oil chamber C. Therefore, in the damper 1 with a uni-flow structure, since the control valve 21 is provided in the annular passage 14F of the first passage which is connected to the outlet side of the electrode passage 19, wide-range tuning of damping force characteristics can be achieved.

### EXAMPLES

The following gives examples of the modes of working the present invention. However, the scope of this invention is not limited to the scope of these working examples.

### Example 1: Preparation of a Non-Aqueous Suspension (Suspension 1)

To 1000 g of a silicone oil (KF96-5cs; produced by Shin-Etsu Chemical Co., Ltd.), 771 g of a liquid prepolymer (polyol; produced by Perstorp Japan Co. Ltd.) and 8 g of LiCl (produced by Wako Pure Chemical Industries, Ltd.) were added, and the mixture was stirred until the salt dissolved. Then, 13 g of an emulsifier (OF7747; produced by Momentive Performance Materials Inc.) was added, followed by addition of 208 g of toluene diisocyanate (produced by Tokyo Chemical Industry Co., Ltd.) as a curing agent (NCO/OH equivalent ratio=1.0), and the mixture was reacted by heating at 75° C. for 5 hours, whereby a non-aqueous suspension (suspension 1) was prepared.

The average particle size of particles in the non-aqueous suspension (suspension 1) was 5 m, as determined using a laser diffraction/scattering analyzer produced by Horiba Ltd. Also, as a result of ion content determination by ICP-MS (inductively coupled plasma-mass spectrometry) performed after production of this non-aqueous suspension, the lithium ion content was determined to be 400 ppm. Further, as detailed later, the logarithmic value of frequency factor in suspension 1 is calculated as 21.1. The concentration of polyurethane particles in this non-aqueous suspension is about 50 mass %.

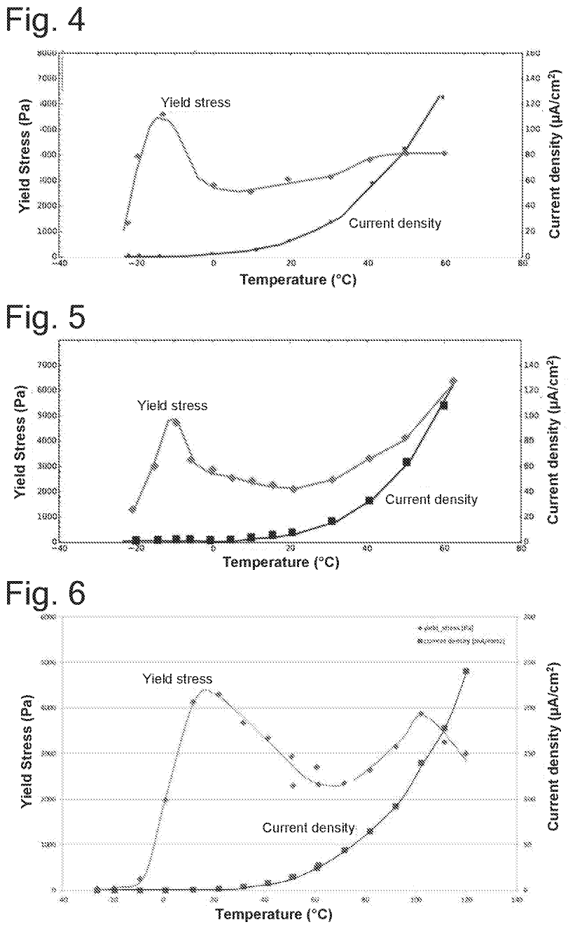

FIG. 4 shows the relationship of yield stress and current density with temperature when a 5 kV/mm voltage was applied to this non-aqueous suspension. The yield stress was determined as follows: in a damper constructed by arranging this non-aqueous suspension between two electrodes (i.e., a damper as shown in FIGS. 2 and 3 which has no high resistance membrane on an electrode surface), a voltage (5 kV/mm) was applied between the electrodes, and a difference between the inlet and outlet pressures of this non-aqueous suspension flowing between the electrodes was measured. The current density was determined by dividing the value of current flowing between the electrodes by electrode surface area.

The results of yield stress determination revealed that a yield stress of 1000 Pa or more can be achieved even at a low temperature of −20° C. (the yield stress achieved at −10° C. be 4500 Pa). However, the current density at a temperature of 60° C. exceeded 100 μA/cm²; thus, it was found that when a damper is constructed using suspension 1, a large amount of power needs to be applied to the damper in order to achieve the desired damping force (ER effect) at 60° C.

### Example 2: Preparation of a Non-Aqueous Suspension (Suspension 2)

A non-aqueous suspension (suspension 2) was prepared by following the same procedure as in Example 1, except that 9 g of LiCl was added.

The average particle size of particles in the non-aqueous suspension (suspension 2) was 5 m, as determined using a laser diffraction/scattering analyzer produced by Horiba Ltd. Also, as a result of ion content determination by ICP-MS (inductively coupled plasma-mass spectrometry) performed after production of this non-aqueous suspension, the lithium ion content was determined to be 450 ppm. Further, as detailed later, the logarithmic value of frequency factor in suspension 2 is calculated as 24.3. The concentration of polyurethane particles in this non-aqueous suspension is about 50 mass %.

The results of yield stress determination revealed that suspension 2 can achieve a yield stress of 1000 Pa or more even at a low temperature of −20° C. (the yield stress achieved at −10° C. be 3000 Pa).

### Example 3: Preparation of a Non-Aqueous Suspension (Suspension 3)

A non-aqueous suspension (suspension 3) was prepared by following the same procedure as in Example 1, except that 166.4 g of toluene diisocyanate was added (NCO/OH equivalent ratio=0.8) and that 0.06 g of LiCl (produced by Wako Pure Chemical Industries, Ltd.) and 1.34 g of ZnCl₂ (produced by Wako Pure Chemical Industries, Ltd.) were used instead of 8 g of LiCl.

The average particle size of particles in the non-aqueous suspension (suspension 3) was 5 μm, as determined using a laser diffraction/scattering analyzer produced by Horiba Ltd. Also, as a result of ion content determination by ICP-MS (inductively coupled plasma-mass spectrometry) performed after production of this non-aqueous suspension, the contents of lithium and zinc ions were determined to be 3 ppm and 300 ppm, respectively (total: 303 ppm). Further, as detailed later, the logarithmic value of frequency factor in suspension 3 is calculated as 26.6. The concentration of polyurethane particles in this non-aqueous suspension is about 50 mass %.

FIG. 5 shows the relationship of yield stress and current density with temperature when a 5 kV/mm voltage is applied to this non-aqueous suspension. The yield stress was determined as follows: in a damper constructed by arranging this non-aqueous suspension between two electrodes (i.e., a damper as shown in FIGS. 2 and 3 which has no high resistance membrane on an electrode surface), a voltage (5 kV/mm) was applied between the electrodes, and a difference between the inlet and outlet pressures of this non-aqueous suspension flowing between the electrodes was measured. The current density was determined by dividing the value of current flowing between the electrodes by electrode surface area.

The results of yield stress determination revealed that a yield stress of 1000 Pa or more can be achieved even at a low temperature of −20° C. (the yield stress achieved at −10° C. be 2500 Pa). However, the current density at a temperature of 60° C. exceeded 100 μA/cm²; thus, it was found that when a damper is constructed using suspension 3, a large amount of power needs to be applied to the damper in order to achieve the desired damping force (ER effect) at 60° C.

### Example 4: Preparation of a Non-Aqueous Suspension (Suspension 4)

A non-aqueous suspension (suspension 4) was prepared by following the same procedure as in Example 1, except that 187.2 g of toluene diisocyanate was added (NCO/OH equivalent ratio=0.9) and that 0.06 g of LiCl and 1.34 g of ZnCl₂ were used instead of 8 g of LiCl.

The average particle size of particles in the non-aqueous suspension (suspension 4) was 5 μm, as determined using a laser diffraction/scattering analyzer produced by Horiba Ltd. Also, as a result of ion content determination by ICP-MS (inductively coupled plasma-mass spectrometry) performed after production of this non-aqueous suspension, the contents of lithium and zinc ions were determined to be 3 ppm and 300 ppm, respectively (total: 303 ppm). Further, as detailed later, the logarithmic value of frequency factor in suspension 4 is calculated as 22.3. The concentration of polyurethane particles in this non-aqueous suspension is about 50 mass %.

The results of yield stress determination revealed that suspension 4 can achieve a yield stress of 1000 Pa or more even at a low temperature of −20° C. (the yield stress achieved at −10° C. be 1500 Pa).

### Comparative Example 1: Preparation of a Non-Aqueous Suspension (Suspension 5)

A non-aqueous suspension (suspension 5) was prepared by following the same procedure as in Example 1, except that 0.06 g of LiCl and 1.34 g of ZnCl₂ were used instead of 8 g of LiCl.

The average particle size of particles in the non-aqueous suspension (suspension 5) was 5 m, as determined using a laser diffraction/scattering analyzer produced by Horiba Ltd. Also, as a result of ion content determination by ICP-MS (inductively coupled plasma-mass spectrometry) performed after production of this non-aqueous suspension, the contents of lithium and zinc ions were determined to be 3 ppm and 300 ppm, respectively (total: 303 ppm). Further, as detailed later, the logarithmic value of frequency factor in suspension 5 is calculated as −2.3. The concentration of polyurethane particles in this non-aqueous suspension is about 50 mass %.

FIG. 6 shows the relationship of yield stress and current density with temperature when a 5 kV/mm voltage is applied to this non-aqueous suspension. The yield stress was determined as follows: in a damper constructed by arranging this non-aqueous suspension between two electrodes (i.e., a damper as shown in FIGS. 2 and 3 which has no high resistance membrane on an electrode surface), a voltage (5 kV/mm) was applied between the electrodes, and a difference between the inlet and outlet pressures of this non-aqueous suspension flowing between the electrodes was measured. The current density was determined by dividing the value of current flowing between the electrodes by electrode surface area.

As a result of yield stress determination, at low temperatures less than 0° C., this non-aqueous suspension achieved only a low level of yield stress, and did not achieve a yield stress of 1000 Pa which is required for a suspension to be applied to a damper (the yield stress achieved at −10° C. was 150 Pa). As the temperature rose, the current density increased. However, the current density at 80° C., which is a typical temperature during use in a damper, is not more than 100 μA/cm²—this is a current density applicable to a damper.

### Comparative Example 2: Preparation of a Non-Aqueous Suspension (Suspension 6)

To 1000 g of a silicone oil (KF96-5cs; produced by Shin-Etsu Chemical Co., Ltd.), 765 g of a liquid prepolymer (polyol; produced by Perstorp Japan Co. Ltd.), 0.06 g of LiCl (produced by Wako Pure Chemical Industries, Ltd.) and 1.34 g of ZnCl₂ (produced by Wako Pure Chemical Industries, Ltd.) were added, and the mixture was stirred until the salt dissolved. Then, 13 g of an emulsifier (OF7747; produced by Momentive Performance Materials Inc.) was added, followed by addition of 195 g of diphenylmethane diisocyanate (produced by Tokyo Chemical Industry Co., Ltd.) as a curing agent (NCO/OH equivalent ratio=1.0), and the mixture was reacted by heating at 75° C. for 5 hours, whereby a non-aqueous suspension (suspension 6) was prepared.

The average particle size of particles in the non-aqueous suspension (suspension 6) was 5 μm, as determined using a laser diffraction/scattering analyzer produced by Horiba Ltd. Also, as a result of ion content determination by ICP-MS (inductively coupled plasma-mass spectrometry) performed after production of this non-aqueous suspension, the contents of lithium and zinc ions were determined to be 3 ppm and 300 ppm, respectively (total: 303 ppm). Further, as detailed later, the logarithmic value of frequency factor in suspension 6 is calculated as 14.5. The concentration of polyurethane particles in this non-aqueous suspension is about 50 mass %.

As a result of yield stress determination, at low temperatures less than 0° C., suspension 6 achieved only a low level of yield stress, and did not achieve a yield stress of 1000 Pa which is required for a suspension to be applied to a damper (the yield stress achieved at −10° C. be 368 Pa).

### Comparative Example 3: Preparation of a Non-Aqueous Suspension (Suspension 7)

To 970 g of a silicone oil (KF96-5cs; produced by Shin-Etsu Chemical Co., Ltd.), 766 g of a liquid prepolymer (polyol; produced by Perstorp Japan Co. Ltd.), 0.06 g of LiCl (produced by Wako Pure Chemical Industries, Ltd.) and 1.34 g of ZnCl₂ (produced by Wako Pure Chemical Industries, Ltd.) were added, and the mixture was stirred until the salt dissolved. Then, 22 g of an emulsifier (OF7747; produced by Momentive Performance Materials Inc.) was added, followed by addition of 202 g of toluene diisocyanate (produced by Tokyo Chemical Industry Co., Ltd.) as a curing agent (NCO/OH equivalent ratio=1.0), and the mixture was reacted by heating at 75° C. for 5 hours, whereby a non-aqueous suspension (suspension 7) was prepared.

The average particle size of particles in the non-aqueous suspension (suspension 7) was 5 μm, as determined using a laser diffraction/scattering analyzer produced by Horiba Ltd. Also, as a result of ion content determination by ICP-MS (inductively coupled plasma-mass spectrometry) performed after production of this non-aqueous suspension, the contents of lithium and zinc ions were determined to be 3 ppm and 300 ppm, respectively (total: 303 ppm). Further, as detailed later, the logarithmic value of frequency factor in suspension 7 is calculated as 17.4. The concentration of polyurethane particles in this non-aqueous suspension is about 50 mass %.

As a result of yield stress determination, at low temperatures less than 0° C., suspension 7 achieved only a low level of yield stress, and did not achieve a yield stress of 1000 Pa which is required for a suspension to be applied to a damper (the yield stress achieved at −10° C. be 750 Pa).

Table 1 summarizes, for each of suspensions 1 to 7 prepared as described above, the yield stresses achieved at −10° C. and 60° C. and the logarithmic value of frequency factor in Arrhenius equation for the current density (μA/cm²) flowing between the electrodes upon application of a 5 kV/mm voltage.

TABLE 1

| | | | Logarithmic |
|---|---|---|---|
| | Yield stress (Pa) | | value of |
| Suspension | −10° C. | 60° C. | frequency factor |
| Suspension 1 | 4500 | 3900 | 21.1 |
| Suspension 2 | 3000 | 5500 | 24.3 |
| Suspension 3 | 2500 | 5800 | 26.6 |
| Suspension 4 | 1500 | 3400 | 22.3 |
| Suspension 5 | 150 | 3050 | −2.3 |
| Suspension 6 | 368 | 3200 | 14.5 |
| Suspension 7 | 750 | 3000 | 17.4 |

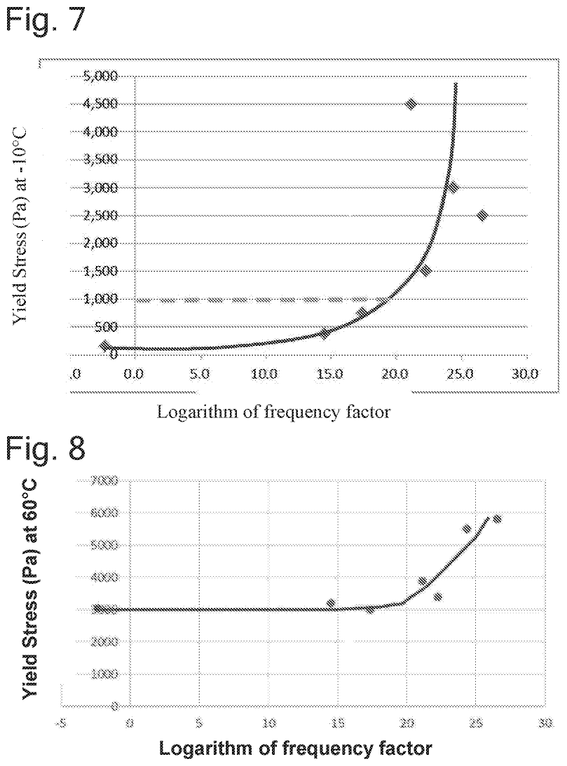

FIG. 7 depicts the correlation, in each of the prepared suspensions, between the yield stress (Pa) at −10° C. and the logarithmic value of frequency factor in Arrhenius equation for the current density (MA/cm²) flowing between the electrodes upon application of a 5 kV/mm voltage.

The results in FIG. 7 revealed that a yield stress of 1000 Pa or more can be achieved when the logarithmic value of frequency factor is 20 or more.

Also, FIG. 8 depicts the correlation, in each of the prepared suspensions, between the yield stress (Pa) at 60° C. and the logarithmic value of frequency factor in Arrhenius equation for the current density (μA/cm²) flowing between the electrodes upon application of a 5 kV/mm voltage.

The results in FIG. 8 revealed that, like the yield stress at −10° C., the yield stress at 60° C. rapidly increases when the logarithmic value of frequency factor reaches 20 or more.

From this, it was found that upon application of a 5 kV/mm voltage to the inventive non-aqueous suspensions, a yield stress (Pa) of 1000 Pa or more can be achieved at a temperature of −10° C., when the logarithmic value of frequency factor in Arrhenius equation for the current density (μA/cm²) flowing between the electrodes is 20 or more.

### Example 5: Effect of a High Resistance Membrane

For the purpose of determination of yield stress and current density, a damper as shown in FIGS. 2 and 3 (i.e., a damper having a high resistance membrane formed on the surface of an electrode), in which a 0.5 m-thick melamine resin membrane (specific resistance: 10¹² to 10¹⁴ 2 cm) as a high resistance membrane was formed only on one of two electrodes, was constructed using the non-aqueous suspension (suspension 1) prepared in Example 1. And yield stress and current density under application of a 5 kV/mm voltage were determined at varied temperatures.

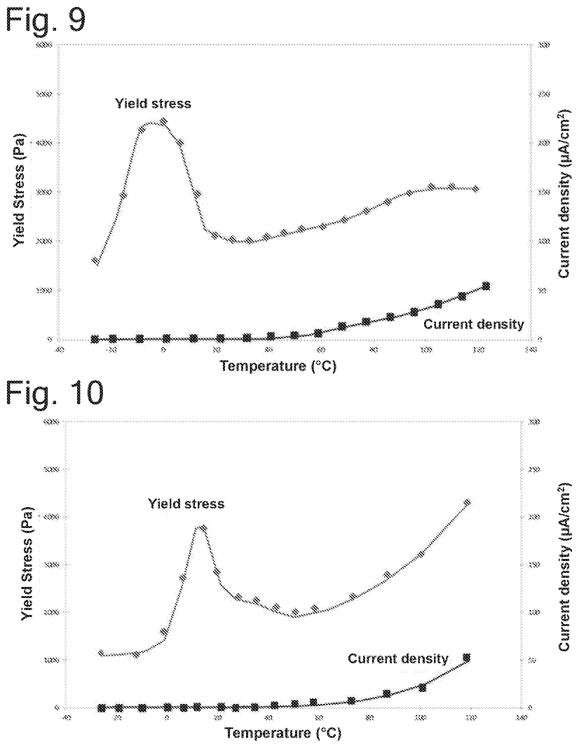

The determination results are shown in FIG. 9. By comparing FIG. 9 with FIG. 4, it is found that little decrease in yield stress is observed at a low temperature of −20° C. whereas the current density is kept sufficiently low at temperatures of 60° C. or more. This is considered to be because high resistance is created due to superimposition of the electrical resistance of the melamine resin on that of the non-aqueous suspension located between the electrodes so that the current is kept low even under application of the same voltage of 5 kV/mm.

### Example 6: Effect of a High Resistance Membrane

For the purpose of determination of yield stress and current density, a damper as shown in FIGS. 2 and 3, in which a 0.5 μm-thick high resistance membrane was formed on each of the electrodes—i.e., a phenol resin membrane (specific resistance: 10⁹ to 10¹² Ωcm) with a total thickness of 1 m was formed on the electrodes, was constructed using the non-aqueous suspension (suspension 3) prepared in Example 3. And yield stress and current density under application of a 5 kV/mm voltage were determined at varied temperatures.

The determination results are shown in FIG. 10. By comparing FIG. 10 with FIG. 5, it is found that there is not so much decrease in yield stress at a low temperature of −20° C. whereas the current density is kept sufficiently low at temperatures of 60° C. or more. This is considered to be because high resistance is created due to superimposition of the electrical resistance of the phenol resin on that of the non-aqueous suspension located between the electrodes so that the current is kept low even under application of the same voltage of 5 kV/mm.

The results obtained in Examples 5 and 6 revealed that dampers constructed using the non-aqueous suspension of an embodiment of this invention and electrodes having a high resistance membrane disposed on the surface thereof can serve as dampers capable of delivering a damping force over a wide temperature range from low (e.g., −20° C.) to high (e.g., 80° C. or more) temperatures.

Although some embodiments of the present invention have been described hereinabove, the embodiments described above are intended merely to facilitate an understanding of this invention, and not to limit the scope of this invention. Various modifications and variations can be made to this invention without departing the spirit of the invention, and equivalents thereof are also included in this invention. Further, any combinations or omissions of the constitutional elements described in the scope of claims and the description are possible to the extent that at least part of the aforementioned objects can be achieved or that at least part of the effects of the invention can be exhibited.

The present application claims priority based on Japanese Patent Application No. JP 2017-156522 filed on Aug. 14, 2017. The disclosures in all documents pertaining to Japanese Patent Application No. JP 2017-156522 filed on Aug. 14, 2017, including description, scope of claims, drawings and abstract, are incorporated herein by reference in their entirety.

### REFERENCE SIGNS LIST

1: damper, 2: non-aqueous suspension of an embodiment of this invention (working fluid), 3: inner cylinder (cylinder), 4: outer cylinder (cylinder), 6: piston, 7: contraction-side check valve (first check valve), 9: piston rod, 13: bottom valve (body valve), 14: valve body, 14E: radial passages (first passage), 14F: annular passage (first passage), 15: extension-side check valve (second check valve), 17: holding member-side passage (first passage), 18: electrode cylinder (intermediate cylinder), 19: electrode passage (intermediate passage, oil passage), 21: control valve, 21A: disc (shutoff valve), 21B: plate spring (elastic member), A: reservoir chamber (reservoir), B: rod-side oil chamber (first chamber), C: bottom-side oil chamber (second chamber)

1. A non-aqueous suspension exhibiting an electrorheological effect, comprising:
a non-aqueous liquid;
organic polymer particles dispersed in the non-aqueous liquid, wherein the organic polymer particles have at least one type of ion in the inside or on the surface of the organic polymer particles; and
a salt,
wherein when a 5 kV/mm voltage is applied between a pair of electrodes, the logarithmic value of frequency factor in Arrhenius equation for the current density (μA/cm²) flowing between the electrodes through the non-aqueous suspension is 20 or more.

2. The non-aqueous suspension according to claim 1, wherein the organic polymer particles are polyurethane particles obtained by reacting a polyol with an isocyanate to give a NCO/OH equivalent ratio of 0.6 to 0.9.

3. The non-aqueous suspension according to claim 1, wherein the organic polymer particles are polyurethane particles having an ion content of 400 ppm or more as determined by ICP-MS analysis.

4. The non-aqueous suspension according to claim 3, wherein the organic polymer particles comprise a lithium ion in the inside or on the surface of the organic polymer particles.

5. A damper comprising:
two electrodes;
the non-aqueous suspension according to claim 1 disposed between the two electrodes; and
a high resistance membrane disposed on a surface of at least one of the electrodes, the surface being in contact with the non-aqueous suspension.

6. The non-aqueous suspension according to claim 1, wherein the salt comprises at least one element selected from the group consisting of lithium, zinc, chromium, copper, nickel, cobalt, iron, manganese, and tungsten.

7. A damper comprising:
two electrodes;
the non-aqueous suspension according to claim 2 disposed between the two electrodes; and
a high resistance membrane disposed on a surface of at least one of the electrodes, the surface being in contact with the non-aqueous suspension.

8. A damper comprising:
two electrodes;
the non-aqueous suspension according to claim 3 disposed between the two electrodes; and
a high resistance membrane disposed on a surface of at least one of the electrodes, the surface being in contact with the non-aqueous suspension.

9. A damper comprising:
two electrodes;
the non-aqueous suspension according to claim 4 disposed between the two electrodes; and
a high resistance membrane disposed on a surface of at least one of the electrodes, the surface being in contact with the non-aqueous suspension.

10. A damper comprising:
two electrodes;
the non-aqueous suspension according to claim 6 disposed between the two electrodes; and
a high resistance membrane disposed on a surface of at least one of the electrodes, the surface being in contact with the non-aqueous suspension.

11. The damper according to claim 5, wherein the specific resistance of the high resistance membrane is 10⁹ to 10¹⁴ Ωcm.

12. The damper according to claim 7, wherein the specific resistance of the high resistance membrane is 10⁹ to 10¹⁴ Ωcm.

13. The damper according to claim 8, wherein the specific resistance of the high resistance membrane is 10⁹ to 10¹⁴ Ωcm.

14. The damper according to claim 9, wherein the specific resistance of the high resistance membrane is 10⁹ to 10¹⁴ Ωcm.

15. The damper according to claim 10, wherein the specific resistance of the high resistance membrane is 10⁹ to 10¹⁴ Ωcm.
